(19) United States
(12) Patent Application Publication
(10) Pub. No.: US 2026/0159415 A1
(43) Pub. Date: Jun. 11, 2026

(54) POSITIVE ELECTRODE ACTIVE MATERIAL AND METHOD FOR MANUFACTURING A POSITIVE ELECTRODE ACTIVE MATERIAL

(71) Applicant: Umicore, Brussels (BE)

(72) Inventors: JooEun HYOUNG, Chungcheongnam-do (KR); Maxime BLANGERO, Chungcheongnam-do (KR); HanSol YONG, Chungcheongnam-do (KR); JiHye KIM, Chungcheongnam-do (KR)

(21) Appl. No.: 19/123,193

(22) PCT Filed: Oct. 25, 2023
(86) PCT No.: PCT/EP2023/079777

§ 371 Date: Apr. 22, 2025

(30) Foreign Application Priority Data
Oct. 25, 2022 (EP) 22203499.3

(51) Int. Cl. C01G 53/82; H01M 4/02; H01M 4/525; H01M 10/0525

(52) U.S. Cl. CPC C01G 53/82; H01M 4/525; H01M 10/0525; C01P 2002/90; C01P 2004/03; C01P 2004/51; C01P 2006/40; H01M 2004/021; H01M 2004/028

(57) ABSTRACT

A positive electrode active material for lithium-ion rechargeable batteries comprises particles having Li, M′, and oxygen, wherein M′ comprises Ni, in a content x, wherein x≥80 at %; Co in a content y, wherein 0.01≤y≤20.0 at %; Y in a content b, wherein 0.01≤b≤2.0 at %; and Zr in a content c, wherein 0.01≤c≤2.0 at %, all at % being relative to M′, and optionally Mn and D. D is at least one element selected from B, Ba, Ca, Cr, Fe, Mg, Mo, Nb, S, Si, Sr, Ti, V, W, and Zn. The material comprises monolithic particles, wherein the particles have a Co content Co_{edge} as measured by cross-sectional EDS at an edge of the particles, and a Co content Co_{center} as measured by cross-sectional EDS at a center of the particle, wherein the ratio Co_{edge}/Co_{center}>1.10.

### TECHNICAL FIELD AND BACKGROUND

The present invention relates to a positive electrode active material for lithium-ion rechargeable batteries. More specifically, the present invention relates to a positive electrode active material, comprising monolithic particles having lithium (Li), M′, and oxygen, wherein M′ comprises 80 at % or more of nickel (Ni), yttrium (Y) and zirconium (Zr), and the particles are coated with cobalt (Co). The present invention also relates to a method of manufacturing the positive electrode active material, a battery comprising the positive electrode active material, and use of a battery comprising the positive electrode active material in an electric vehicle or in a hybrid electric vehicle.

It has been reported in Meiling Zhang et al., Journal of Alloys and Compounds, 774, 2019, 82-89 that a Ni-rich, i.e., comprising more than 80 at % Ni, positive electrode active material comprising Y exhibits a noticeably enhanced cycling performance at 4.5 V high voltage. It has been also reported in Chul-Ho Jung et al., J. Mater. Chem. A, 2021, 9, 17415-17424 that a Ni-rich positive electrode active material comprising Zr exhibits enhanced electrochemical performances by alleviating most of degradation factors. CN113871603A discloses a positive electrode active material, which is prepared by heating a mixture of yttrium oxide, zirconia, lithium hydroxide and a precursor comprising Ni, Mn and Co, and comprises polycrystalline particles. Although a Ni-rich positive electrode active material comprising Y and Zr exhibits enhancement in certain electrochemical performances of a lithium-ion rechargeable battery, a method of lowering a direct current resistance (DCR) of a lithium-ion rechargeable battery comprising a Ni-rich positive electrode active material with Y and Zr is unknown. Accordingly, there is a need for a Ni-rich positive electrode active material comprising Y and Zr which has a lowered DCR as well as enhanced electrochemical properties such as a prolonged cycle life.

It is a first object of the present invention to provide a positive electrode active material comprising Y and Zr, wherein a lithium-ion rechargeable battery comprising the positive electrode active material has improved electrochemical properties such as prolonged cycle life and lowered DCR.

It is a second object of the present invention to provide a method for manufacturing a positive electrode active material comprising Y and Zr.

It is a third object of the present invention to provide a battery comprising said positive electrode active material.

It is a fourth object of the present invention to provide a use of said battery comprising said positive electrode active material in an electric vehicle or in a hybrid electric vehicle.

### SUMMARY OF THE INVENTION

The 1^{st} object is achieved by providing a positive electrode active material for lithium-ion rechargeable batteries, wherein the positive electrode active material comprises particles having Li, M′, and oxygen, wherein M′ comprises:
Ni in a content x, wherein x≥80 at %, relative to M′;
Co in a content y, wherein 0.01≤y≤20.0 at %, relative to M′;
Mn in a content z, wherein 0≤z≤20.0 at %, relative to M′;
Y in a content b, wherein 0.01≤b≤2.0 at %, relative to M′;
Zr in a content c, wherein 0.01≤c≤2.0 at %, relative to M′;
D in a content a, wherein 0≤a≤5.0 at %, relative to M′, wherein D is at least one element selected from the list of Al, B, Ba, Ca, Cr, Fe, Mg, Mo, Nb, S, Si, Sr, Ti, V, W, and Zn;
wherein x, y, z, a, b, and c are measured by ICP,
wherein x+y+z+a+b+c is 100.0 at %,
wherein the positive electrode active material comprises monolithic particles,
wherein the particles have a Co content Co_{edge} as measured by cross-sectional EDS (CS-EDS) at an edge of the particles, wherein Co_{edge} is expressed as at % relative to the sum of Ni, Mn, and Co content as measured by CS-EDS at the edge of the particles, wherein the particles have a Co content Co_{center} as measured by CS-EDS at a center of the particle, wherein Co_{center} is expressed as at % relative to the sum of Ni, Mn, and Co content as measured by CS-EDS at the center of the particles, and wherein the ratio Co_{edge}/Co_{center}>1.10.

The 2^{nd} object is achieved by providing a method for manufacturing said positive electrode active material, comprising the consecutive steps of:
a. Mixing a precursor comprising Ni and optionally either one or both of Co and Mn with a Y source, a Zr source, a Li source, and optionally a D source to obtain a first mixture, wherein D is at least one element selected from the list of Al, Ba, Ca, Cr, Fe, Mg, Mo, Nb, S, Si, Sr, Ti, V, W, and Zn,
b. Heating the first mixture at a temperature between 650° C. to 1000° C. to obtain a first heated material,
c. Milling the first heated material to obtain a milled powder,
d. Mixing the milled powder with a Co source to obtain a second mixture,
e. Heating the second mixture at a temperature between 500° C. to 900° C. to obtain the positive electrode active material.

The 3^{rd} object is achieved by providing a battery comprising said positive electrode active material.

The 4^{th} object is achieved by providing a use of said battery comprising said positive electrode active material in an electric vehicle or in a hybrid electric vehicle.

The positive electrode active material according to the present invention has a prolonged cycle life and a lowered DCR when used in a lithium-ion rechargeable battery.

### BRIEF DESCRIPTION OF THE FIGURES

FIG. 1 is a graph showing the cycle lives at 45° C. of CEX1.1, CEX1.2, and EX1.

FIG. 2 is a graph showing the cycle lives at 45° C. of CEX2.1, CEX2.2, CEX2.3, EX2.1, and EX2.2.

FIG. 3 is a graph showing the DCR at 45° C. of CEX1.1, CEX1.2, and EX1.

FIG. 4 is a graph showing the DCR at 45° C. of CEX2.1, CEX2.2, CEX2.3, EX2.1, and EX2.2.

FIG. 5 is a SEM image of EX1.

FIG. 6 is a cross-sectional SEM image of EX1 wherein A is the position of the center of a particle, where Co_{center} is measured, and B is the position of the edge of a particle, where Co_{edge} is measured.

### DETAILED DESCRIPTION

In the following detailed description, preferred embodiments are described in detail to enable practice of the present invention. Although the present invention is described with reference to these specific preferred embodiments, it will be understood that the present invention is not limited to these preferred embodiments. In contrast, the present invention includes numerous alternatives, modifications and equivalents as will become apparent from consideration of the following detailed description.

### Positive Electrode Active Material

In a first aspect, the present invention relates to a positive electrode active material for lithium-ion rechargeable batteries, comprising particles having Li, M′, and oxygen, wherein M′ comprises:
Ni in a content x, wherein x≥80 at %, relative to M′;
Co in a content y, wherein 0.01≤y≤20.0 at %, relative to M′;
Mn in a content z, wherein 0≤z≤20.0 at %, relative to M′;
Y in a content b, wherein 0.01≤b≤2.0 at %, relative to M′;
Zr in a content c, wherein 0.01≤c≤2.0 at %, relative to M′;
D in a content a, wherein 0≤a≤5.0 at %, relative to M′, wherein D is at least one element selected from the list of Al, B, Ba, Ca, Cr, Fe, Mg, Mo, Nb, S, Si, Sr, Ti, V, W, and Zn;
wherein x, y, z, a, b, and c are measured by ICP,
wherein x+y+z+a+b+c is 100.0 at %,
wherein the positive electrode active material comprises monolithic particles,
wherein the particles have a Co content Co_{edge} as measured by cross-sectional EDS (CS-EDS) at an edge of the particles, wherein Co_{edge} is expressed as at % relative to the sum of Ni, Mn, and Co content as measured by CS-EDS at the edge of the particles, wherein the particles have a Co content Co_{center} as measured by CS-EDS at a center of the particle, wherein Co_{center} is expressed as at % relative to the sum of Ni, Mn, and Co content as measured by CS-EDS at the center of the particles, and wherein the ratio Co_{edge}/Co_{center}>1.10.

In the framework of the present invention, the edge of the particle is the boundary or external limit distinguishing the particle from its external environment. The center of the particle is a mid-point of the straight line, which is the longest among the straight lines connected by two points on the edges of the particle.

In the framework of the present invention, at % signifies atomic percentage. The at % or “atomic percent” of a given element means a percentage of atoms of said element among all atoms in a claimed composition.

ICP-OES provides weight percent (wt %) of each of elements included in a material whose composition is determined by this technique. Conversion from wt % to at % is as follows: at % of a first element E₁ (Eₐₜ₁) in a material can be converted from a given wt % of said first element E₁ (E_{wt1}) in said material by applying the following formula:

$${E}_{at 1} = \frac{( {E}_{wt 1} / {E}_{aw 1} )}{{\sum }_{i = 1}^{n} ( {E}_{wti} / {E}_{awi} )} \times 100 \% ,$$

wherein E_{aw1} is a standard atomic weight of the first element E₁, E_{wt1} is wt % of an i^{th} element Eᵢ, E_{awi} is a standard atomic weight of said i^{th} element Eᵢ, and n is an integer which represents the number of types of all elements included in the material.

The inventors of the present invention have found that the prolonged cycle life and the lowered DCR of a lithium-ion rechargeable battery are achieved by the positive electrode active material according to the present invention. In detail, the inventors of the present invention have found that the lithium-ion rechargeable battery comprising the positive electrode active material according to the present invention, wherein the material comprises 80 at % or more of Ni, wherein Y and Zr are added, wherein monolithic particles are included, and wherein the ratio Co_{edge}/Co_{center}>1.10, has a prolonged cycle life and lowered DCR.

In the framework of the present invention, “monolithic” particles are particles, each of which contains only one primary particle, as observed in a SEM image.

Monolithic particles can maintain their morphological integrity even if operated under extreme conditions, and thus, the contact area between the electrolyte and the monolithic particles due to the generation of microcracks is reduced as compared to polycrystalline particles. The reduction of the contact area decreases gas evolution caused by additional side reactions between the electrolyte and the monolithic particles, and also decreases DCR.

In certain preferred embodiments, the positive electrode active material according to the invention is a powder comprising single particles and/or secondary particles, wherein each of the single particles consist of only one primary particle and each of the secondary particles consist of at least two primary particles and at most twenty primary particles as observed in a SEM image. Preferably, at least 30% of the particles, more preferably at least 50% of the particles, constituting the powder observed in a SEM image are the single particles and/or the secondary particles. The number of primary particles constituting the single particles and/or the secondary particles are determined in a field of view of at least 45 μm×at least 60 μm (i.e. of at least 2700 μm²), preferably of: at least 100 μm×100 μm (i.e. of at least 10,000 μm². The particles in the image should be well distributed therefore avoiding overlap between particles. This can be achieved by pouring a small amount of powder sample to the adhesive attached on the SEM sample holder and blowing air to remove the excess powder. In the context of the present invention primary particles are distinguished from each other in a SEM image by observing grain boundaries between the primary particles. A grain boundary is defined as the interface between two primary particles, preferably wherein the atomic planes of the two primary particles are aligned to different orientations and meet as a crystalline discontinuity.

In a preferred embodiment, Co_{edge}/Co_{center} may be more than 1.50, preferably more than 1.65, more preferably more than 1.80.

In a preferred embodiment, x may be 85 at % or more, preferably 86.5 at % or more, more preferably 88 at % or more.

In a preferred embodiment, x may be less than 98.5 at %, preferably less than 96 at %, more preferably less than 94 at %.

In a preferred embodiment, (y+z) may be more than 1.0 at %, preferably more than 3.0 at %, more preferably more than 5.0 at %.

In a preferred embodiment, b may be 0.02 at % or more, preferably 0.03 at % or more, more preferably 0.04 at % or more.

In a preferred embodiment, b may be 2.0 at % or less, preferably 1.0 at % or less, more preferably 0.5 at % or less.

In a preferred embodiment, c may be 0.08 at % or more, preferably 0.10 at % or more, more preferably 0.12 at % or more.

In a preferred embodiment, c may be 2.0 at % or less, preferably 1.0 at % or less, more preferably 0.5 at % or less.

In a preferred embodiment, the particle median size D50 may be at least 2.0 μm and at most 15.0 μm, as determined by laser diffraction particle size analysis.

In a preferred embodiment D is a content a, wherein 0≤a≤5.0 at %, relative to M′, preferably wherein 0≤a≤2.0 at %, more preferably wherein 0≤a≤1.0 at %, most preferably a is about 0, relative M′.

In a preferred embodiment D is at least one element selected from the list of Al, B, Mo, Nb, Sr, Ti, V, W, and Zn; preferably D is at least one element selected from the list of Al, B, Nb, Sr, Ti and W. In a certain preferred embodiment D is Al.

### Method for Manufacturing Positive Electrode Active Material

In a second aspect, the present invention relates to a method for manufacturing a positive electrode active material according to the first aspect, comprising the consecutive steps of:
a. Mixing a precursor comprising Ni and optionally either one or both of Co and Mn with a Y source, a Zr source, a Li source, and optionally a D source to obtain a first mixture, wherein D is at least one element selected from the list of Al, Ba, Ca, Cr, Fe, Mg, Mo, Nb, S, Si, Sr, Ti, V, W, and Zn
b. Heating the first mixture at a temperature between 650° C. to 1000° C. to obtain a first heated material,
c. Milling the first heated material to obtain a milled powder,
d. Mixing the milled powder with a Co source to obtain a second mixture,
e. Heating the second mixture at a temperature between 500° C. to 900° C. to obtain the positive electrode active material.

The positive electrode active material manufactured by the method according to the second aspect comprises monolithic particles. The temperature of the step of heating the first mixture is high enough to promote the growth of primary particles in the first heated material. Then, the first heated material is milled to form monolithic particles. Preferably, the milling is a wet bead milling.

In a preferred embodiment, the Y source may be at least one selected from the group consisting of yttrium oxide, and yttrium zirconium oxide compound. Yttrium oxide may be Y₂O₃, and yttrium zirconium oxide may be Y_{0.3}Zr_{0.7}O_{1.85}.

In a preferred embodiment, the Zr source may be at least one selected from the group consisting of zirconium oxide, lithium zirconium oxide, and yttrium zirconium oxide compound. Zirconium oxide may be ZrO₂, lithium zirconium oxide may be Li₂ZrO₃, and yttrium zirconium oxide may be Y_{0.3}Zr_{0.7}O_{1.85}.

In a preferred embodiment, both the Y source and Zr source may be yttrium zirconium oxide compound. Yttrium zirconium oxide may be Y_{0.3}Zr_{0.7}O_{1.85}.

The inventors of the present invention have found that the lithium-ion rechargeable battery comprising the positive electrode active material, which is manufactured by using yttrium zirconium oxide as Y and Zr sources during the step a of mixing the precursor, has longer cycle life and lower DCR than the lithium-ion rechargeable battery comprising the positive electrode active material, which is manufactured by using zirconium oxide and/or lithium zirconium oxide as a Zr source and yttrium oxide as a Y source during the step a of mixing the precursor.

In a preferred embodiment, said first heated material obtained during the step b of heating the first mixture may be mixed in an aqueous solution comprising Co by using wet bead milling.

### Battery

In a third aspect, the present invention relates to a battery comprising the positive electrode active material according to the first aspect.

### Use of Battery

In a fourth aspect, the present invention relates to a use of the battery according to the third aspect.

As appreciated by a person skilled in the art, all embodiments directed to the positive electrode active material according to the first aspect may apply mutatis mutandis to the second, third and fourth aspects.

### Experimental Tests Used in the Examples

The following analysis methods are used in the Examples:

### A) Particle Size Distribution (PSD) Analysis

The PSD is measured using a Malvern Mastersizer 3000 with Hydro MV wet dispersion accessory after dispersing examples as described herein below of positive electrode active material powders in an aqueous medium. To improve the dispersion of the positive electrode active material powder examples, sufficient ultrasonic irradiation and stirring is applied, and an appropriate surfactant is introduced. D50 is defined as the particle size at 50% of the cumulative volume % distribution.

### B) Inductively Coupled Plasma-Optical Emission Analysis (ICP-OES)

The contents of the metals in positive electrode active material examples as described herein below are measured by the Inductively Coupled Plasma-Optical Emission Spectrometry (ICP-OES) method using an Agillent ICP 720-OES. 1 gram of a powder sample of each example is dissolved into 50 mL high purity hydrochloric acid in an Erlenmeyer flask. The flask is covered by a watch glass and heated on a hot plate at 380° C. until complete dissolution of the sample. After being cooled to room temperature, the solution and the rinsing water of Erlenmeyer flask are transferred to a 250 mL volumetric flask. Afterwards, the volumetric flask is filled with DI water up to the 250 mL mark, followed by complete homogenization. An appropriate amount of solution is taken out by pipette and transferred into a 250 mL volumetric flask for the 2^{nd} dilution, where the volumetric flask is filled with internal standard and 10% hydrochloric acid up to the 250 mL mark and then homogenized. Finally, this solution is used for ICP-OES measurement. The contents of Ni, Mn, Co, Y, and Zr are expressed as wt % of the total of these contents.

### C) Cross-Section Energy-Dispersive X-Ray Spectroscopy (CS-EDS)

### C1) Cross-Section Preparation

Cross-sections of the positive electrode active material examples as described herein below are prepared by an ion beam cross-section polisher (CP) instrument JEOL (IB-19530CP). The instrument uses argon gas as beam source.

To prepare the specimen, a small amount of a positive electrode active material powder is mixed with a resin and hardener, then the mixture is heated for 10 minutes on a hot plate.

After heating, it is placed into the ion beam instrument for cutting and the settings are adjusted in a standard procedure, with a voltage of 6.5 kV for a 3 hours duration.

### C2) Energy-Dispersive X-Ray Spectroscopy (EDS) Analysis

Using the examples of the positive electrode active materials prepared according to method C1) above, the concentrations of Ni, Mn, and Co from the edge to the center of the positive electrode active material particles are analyzed by energy-dispersive X-ray spectroscopy (EDS). A particle with a diameter around D50 value as measured by PSD according to Section A) is selected for analysis for each of the examples. The EDS is performed by JEOL JSM 7100F SEM equipment with a 50 mm² X-MaxN EDS sensor from Oxford instruments. An EDS analysis of the positive electrode active material particles provides the quantitative element analysis of the cross-section wherein it is assumed that particles are spherical. A straight line is set from the edge to the center point of the particle and Ni, Mn, and Co concentrations are measured at edge and center and expressed as a at % relative to the sum of Ni, Mn, and Co content at each point.

### D) Full Cell Testing

### D1) Full Cell Preparation

2000 mAh pouch-type cells are prepared as follows: the positive electrode active material powder, Super-P (Super-P, Imerys Graphite & Carbon) as positive electrode conductive agents, and polyvinylidene fluoride (PVDF S5130, Solvay) as a positive electrode binder are added to N-methyl-2-pyrrolidone (NMP) as a dispersion medium so that the mass ratio of the positive electrode active material powder, the positive electrode conductive agents: super P: positive electrode binder is set at 95/3/2. Thereafter, the mixture is kneaded to prepare a positive electrode mixture slurry. The resulting positive electrode mixture slurry is then applied onto both sides of a positive electrode current collector, made of a 20 μm thick aluminum foil. The width of the applied area is 88.5 mm and the length is 425 mm. Typical loading weight of a positive electrode active material is about 14.8±1 mg/cm². The electrode is then dried and calendared using a pressure of 4.5 MPa. In addition, an aluminum plate serving as a positive electrode current collector tab is arc-welded to an end portion of the positive electrode.

Commercially available negative electrodes are used. In short, a mixture of artificial graphite, carbon (Super P (Imerys)), carboxy-methyl-cellulose-sodium, and styrene-butadiene-rubber, in a mass ratio of 95.0/1/1.5/2.5, is applied on both sides of a copper foil. A nickel plate serving as a negative electrode current collector tab is arc-welded to an end portion of the negative electrode. Typical loading weight of a negative electrode active material is about 10±1 mg/cm².

Non-aqueous electrolyte is obtained by dissolving lithium hexafluorophosphate (LiPF₆) salt at a concentration of 1.2 mol/L in a mixed solvent of ethylene carbonate (EC), ethyl methyl carbonate (EMC), and diethyl carbonated (DEC) in a volume ratio of 1:1:1. It contains 1.0 wt. % lithium difluorophosphate (LiPO₂F₂), and 1.0 wt. % vinylene carbonate (VC) as additives.

A sheet of the positive electrode, a sheet of the negative electrode, and a sheet of the microporous polymer separator (13 μm) interposed between them are spirally wound using a winding core rod in order to obtain a spirally wound electrode assembly. The assembly and the electrolyte are then put in an aluminum laminated pouch in an air-dry room with dew point of −50° C., so that a flat pouch-type lithium secondary battery is prepared. The design capacity of the secondary battery is 2000 mAh when charged to 4.20 V. The full cell testing procedure uses a 1 C current definition of 2000 mA/g.

### D2) Cycle Life Test

### A. Pre-Charging and Formation

The non-aqueous electrolyte solution is impregnated into the prepared dry battery for 8 hours at room temperature. The battery is pre-charged with the current of 0.25 C until 14% of its theoretical capacity and aged for a day at room temperature. The battery is then degassed using a pressure of −760 mmHg for 30 seconds, and the aluminum pouch is sealed. During measurement, the pouch is assembled in a press jig provided with silicon pad.

The battery is charged with a current of 0.2 C in CC mode (constant current) up to 4.2 V and CV mode (constant voltage) until a cut-off current of C/20 is reached. The battery is discharged with a current of 0.2 C in CC mode down to 2.7 V. Then, it is fully charged with a current of 0.50 C in CC mode up to 4.2 V and CV mode until a cut-off current of C/20 is reached.

Afterwards, cell is discharged with a current of 0.50 C in CC mode down to 2.7 V. It is again charged with a current of 0.5 C in CC mode up to 4.2 V and CV mode until a cut-off current of C/20 is reached. The final charging step is done in 25° C.

### B. Cycle Life Test

The lithium secondary full cell batteries are charged and discharged continuously under the following conditions at 45° C., to determine their charge-discharge cycle performance:
Charge is performed in CC mode under 1 C rate up to 4.2 V, then CV mode until C/20 is reached,
The cell is then set to rest for 10 minutes,
Discharge is done in CC mode at 1 C rate down to 2.7 V,
The cell is then set to rest for 10 minutes,
The charge-discharge cycles proceed until 600 cycles. Every 100 cycles, the discharge is done at 0.1 C rate in CC mode down to 2.7 V.

The internal resistance or direct current resistance (DCR) is measured at 1.5C for 10 s at the beginning of every 100 cycles repetition and the end of 600^{th} cycles.

The cycle life is defined as the number of charge-discharge cycles when the capacity degrades to 80%.

### E) FE-SEM Analysis

The morphology of a material is analyzed by a Scanning Electron Microscopy (SEM) technique. The measurement is performed with a JEOL JSM 7100F scanning electron microscope equipment under a high vacuum environment of 9.6×10−5 Pa at 25° C.

### EXAMPLES

The present invention is further illustrated in the following examples:

### Comparative Example 1

Positive electrode active material CEX1.1 is prepared through a solid-state reaction between a lithium source and a transition metal-based source precursor according to the following steps:

1. Co-precipitation: a transition metal oxidized hydroxide precursor with metal composition of Ni_{0.90}Mn_{0.05}Co_{0.05} is prepared by a co-precipitation process in a large-scale continuous stirred tank reactor (CSTR) with mixed nickel manganese cobalt sulfates, sodium hydroxide, and ammonia.
2. First mixing: the precursor prepared from Step 1) is mixed with LiOH in an industrial blender to obtain a first mixture having a lithium to metal ratio of 0.99.
3. First heating: the mixture from Step 2) is heated under oxygen flow at a first temperature of 890° C. for 12 hours to obtain a first heated material.
4. Wet bead milling: the first heated material is bead milled in a solution containing 0.5 at % Co with respect to the total molar contents of Ni, Mn, and Co in the first heated product followed by drying and sieving process to obtain a milled product. The bead milling solid to solution weight ratio was 10:7 and was conducted for 50 minutes.
5. Second mixing: the milled product from Step 4) was mixed with 1.5 at % Co from nano-Co oxide powder and 0.25 at % Zr from ZrO₂ powder.
6. Heat treatment: the second mixture from Step 5) was heated at 770° C. for 12.5 hours under an oxygen atmosphere to obtain CEX1.1. CEX1.2 is prepared according to the same method as CEX1.1, except that ZrO₂ powder is added together with Li in the first mixing thereby obtaining the first mixture comprising 0.25 at % Zr and lithium to metal ratio of 0.99 and ZrO₂ is not added in the second mixing.

### Example 1

EX1 is prepared according to the same method as CEX1.1, except that Y_{0.3}Zr_{0.7}O_{1.85} powder is added together with LiOH in the first mixing thereby obtaining the first mixture comprising 0.175 at % Zr, 0.075 at % Y, and lithium to metal ratio of 0.99 and ZrO₂ is not added in the second mixing.

### Comparative Example 2

Positive electrode active material CEX2.1 is prepared through a solid-state reaction between a lithium source and a transition metal-based source precursor according to the following steps:

1. Co-precipitation: a transition metal oxidized hydroxide precursor with metal composition of Ni_{0.96}Mn_{0.01}Co_{0.03} is prepared by a co-precipitation process in a large-scale continuous stirred tank reactor (CSTR) with mixed nickel manganese cobalt sulfates, sodium hydroxide, and ammonia.
2. First mixing: the precursor prepared from Step 1) is mixed with LiOH, Al₂O₃, and ZrO₂ in an industrial blender to obtain a first mixture having 700 ppm Al, 0.117 at % ZrO₂, lithium to metal ratio of 1.01.
3. First heating: the mixture from Step 2) is heated under oxygen flow at first temperature of 805° C. for 10 hours and then the temperature is decreased to a second temperature of 720° C. for 5 hours to obtain a first heated material.
4. Wet bead milling: the first heated material is bead milled in a solution containing 0.5 at % Co with respect to the total molar contents of Ni, Mn, and Co in the first heated product followed by drying and sieving process to obtain a milled product. The bead milling solid to solution weight ratio was 5:5 and was conducted for 13 hours.
5. Second mixing: the milled product from Step 4) was mixed with LiOH to obtain lithium to metal ratio of 0.99, 1.5 at % Co from nano-Co oxide powder (Co₃O₄), 500 ppm Nb from Nb₂O₅, and 500 ppm Al from Al₂O₃ powder.
6. Heat treatment: the second mixture from Step 5) was heated at 710° C. for 12.5 hours under an oxygen atmosphere to obtain CEX2.1.

CEX2.2 is prepared according to the same method as CEX2.1, except that 0.025 at % Y₂O₃ is added together with LiOH and Al₂O₃ instead of ZrO₂ powder in the first mixture.

CEX2.3 is prepared according to the same method as CEX2.1, except that (i) Y_{0.3}Zr_{0.7}O_{1.85} powder is added together with LiOH and Al₂O₃ in the first mixing instead of ZrO₂ powder, thereby obtaining the first mixture comprising 0.117 at % Zr, 0.050 at % Y, and lithium to metal ratio of 1.01, (ii) the wet bead milling is conducted in water instead of the Co solution, and (iii) Co₃O₄ is not added in the second mixing.

### Example 2

EX2.1 is prepared according to the same method as CEX2.1, except that Y_{0.3}Zr_{0.7}O_{1.85} powder is added together with LiOH and Al₂O₃ in the first mixing instead of ZrO₂ powder, thereby obtaining the first mixture comprising 0.117 at % Zr, 0.050 at % Y, and lithium to metal ratio of 0.99.

EX2.2 is prepared according to the same method as CEX2.1 except that 0.025 at % Y₂O₃ is added together with LiOH, Al₂O₃ and ZrO₂ in the first mixing.

### Results

TABLE 1
Summary of the composition and the corresponding electrochemical properties of examples and comparative examples

| | Compound added in process step* | | | | | | | Full cell | |
|---|---|---|---|---|---|---|---|---|---|
| Patent | | Wet | | ICP (at %) | | | | Number of cycles | DCR at 600 |
| ID | 1^{st} mixing | milling | 2^{nd} mixing | Ni | Co | Zr | Y | at 80% of capacity | cycles (%) |
| CEX1.1 | n.a | CoSO₄ | Co₃O₄, ZrO₂ | 88.1 | 6.9 | 0.214 | — | 2089 | 135.1 |
| CEX1.2 | ZrO₂ | CoSO₄ | Co₃O₄ | 88.1 | 6.9 | 0.218 | — | 2012 | 125.0 |
| EX1 | Y_{0.3}Zr_{0.7}O_{1.85} | CoSO₄ | Co₃O₄ | 88.2 | 6.9 | 0.150 | 0.051 | 2313 | 113.6 |
| CEX2.1 | ZrO₂, Al₂O₃ | CoSO₄ | Co₃O₄, Nb₂O₅, Al₂O₃ | 93.6 | 4.9 | 0.098 | — | 924 | 139.0 |
| CEX2.2 | Y₂O₃, Al₂O₃ | CoSO₄ | Co₃O₄, Nb₂O₅, Al₂O₃ | 93.5 | 4.9 | — | 0.033 | 779 | 158.4 |
| CEX2.3 | Y_{0.3}Zr_{0.7}O_{1.85}, Al₂O₃ | — | Nb₂O₅, Al₂O₃ | 94.0 | 3.0 | 0.108 | 0.046 | 764 | 154.7 |
| EX2.1 | Y_{0.3}Zr_{0.7}O_{1.85}, Al₂O₃ | CoSO₄ | Co₃O₄, Nb₂O₅, Al₂O₃ | 93.6 | 4.9 | 0.095 | 0.037 | 1363 | 116.5 |
| EX2.2 | ZrO₂, Y₂O₃, Al₂O₃ | CoSO₄ | Co₃O₄, Nb₂O₅, Al₂O₃ | 93.6 | 4.9 | 0.094 | 0.032 | 1211 | 126.1 |

*Except LiOH and precursor

TABLE 2
Element concentration as measured by CS-EDX

| | Atomic fraction at the edge of particle | | | Atomic fraction at the center of particle | | | |
|---|---|---|---|---|---|---|---|
| | Ni_{edge} | Mn_{edge} | Co_{edge} | Ni_{center} | Mn_{center} | Co_{center} | Co_{edge}/ |
| ID | (at %) | (at %) | (at %) | (at %) | (at %) | (at %) | Co_{center} |
| EX2.1 | 92.64 | 0.86 | 6.51 | 95.39 | 1.07 | 3.54 | 1.84 |

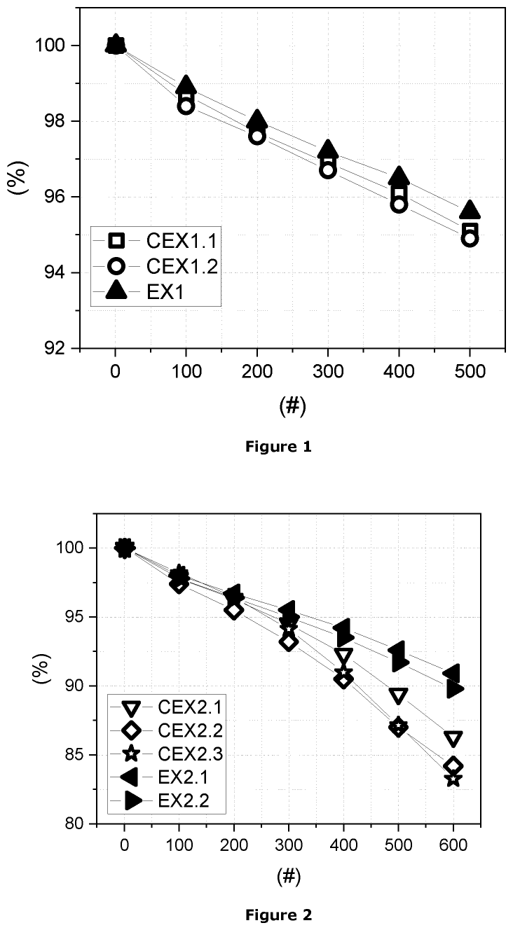

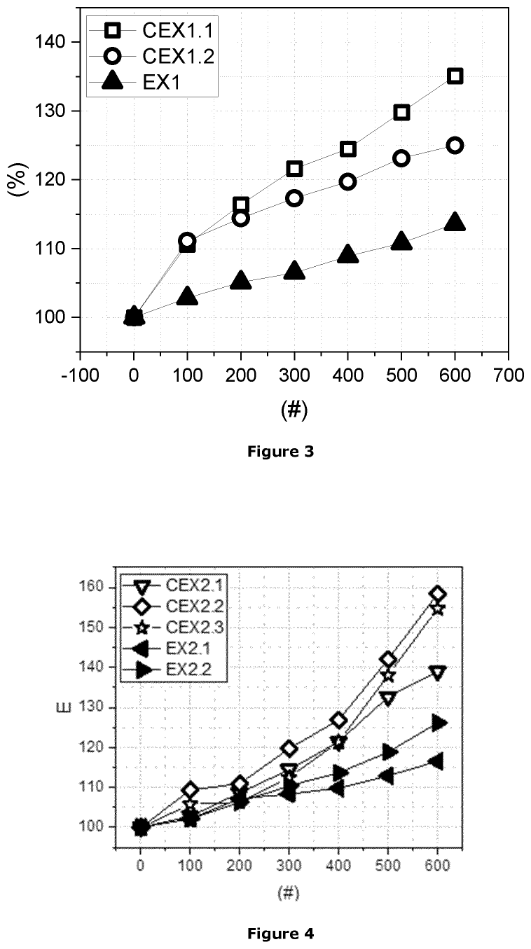

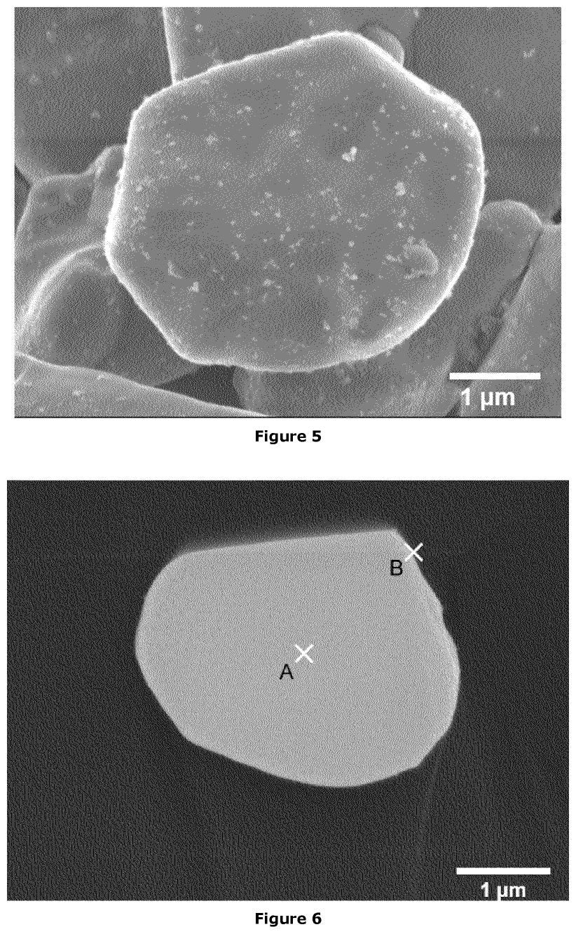

Table 1 summarizes the compounds added in the first mixing, wet milling, and second mixing except precursor and Li source. CEX1.1 and CEX1.2 are positive electrode active material comprises Zr while EX1 further comprises Y. All of the particles in Table 1 are monolithic due to the first temperature at the first mixing and the wet bead milling. FIG. 5 is a SEM image of EX1. It is confirmed that each of the particles of EX1 contains only one primary particle, and thus, each of the particles of EX1 is monolithic. The electrochemical properties, tested by full cell, demonstrate EX1 to have a longer cycle life, exceeding 2300 cycles at 80% of capacity in comparison with CEX1.1 and CEX1.2 as shown in Table 1. FIG. 1 illustrates a graph of capacity vs. number of cycles for CEX1.1, CEX1.2 and EX1 until 500 cycles, and the number of cycles at 80% of capacity is calculated by the linear extrapolation of the obtained data shown in FIG. 1. FIG. 3 also shows that DCR value at 600 cycles for EX1 is lower in comparison with CEX1.1 and CEX1.2 showing the benefit of adding Y altogether with Zr during the first mixing.

CEX2.1, CEX2.2, EX2.1, and EX2.2 are positive electrode active materials, which are different from CEX1.1, CEX1.2 and EX1 in that the content of Ni in CEX2.1, CEX2.2, EX2.1, and EX2.2 is around 93.6 at %, and CEX2.1, CEX2.2, EX2.1, and EX2.2 further comprise Nb and Al. CEX2.1 does not comprise Y and CEX2.2 does not comprise Zr, whereas EX2.1 and EX2.2 comprise both Y and Zr. CEX2.3 is different from EX2.1 in that (i) the step of wet bead milling is conducted in water and not in the solution containing Co, and (ii) Co₃O₄ is not added in the step of second mixing. Thus, Co is not enriched on the edge of the particle of CEX2.3 as compared to EX2.1. The electrochemical properties, tested by full cell, demonstrate EX2.1 and EX2.2 to have a longer cycle life, exceeding 1200 cycles at 80% of capacity in comparison with CEX2.1, CEX2.2 and CEX2.3 as shown in Table 1. FIG. 2 illustrates a graph of capacity vs. number of cycles for CEX2.1, CEX2.2, EX2.1 and EX2.2 until 500 cycles, and the number of cycles at 80% of capacity is calculated by the linear extrapolation of the obtained data shown in FIG. 2. FIG. 4 also shows that DCR value at 600 cycles for EX2.1 and EX2.2 are lower in comparison with CEX2.1 and CEX2.2 showing the benefit of adding Y altogether with Zr during the first mixing. Consistent with the result obtained from the comparison of EX1 to CEX1.2, both EX1.1 and EX1.2 demonstrate improved electrochemical properties in comparison with CEX2.1 and CEX2.2.

The Y and Zr in the first mixing can be added separately in two different sources such as EX2.2 or added in a single source as yttrium zirconium oxide compound such as EX2.1. Comparing the cycle life and DCR of EX2.1 with those of EX2.2 shown in FIGS. 2 and 4, the cycle life of EX2.1 is longer than that of EX2.2, and DCR of EX2.1 is lower than that of EX2.2. This demonstrates that the cycle life and DCR of the positive electrode active material according to the present invention are improved when Y and Zr in the first mixing are added in a single source.

Table 2 exhibits Ni, Mn, and Co content at the edge and center of positive electrode active material particle of EX2.1, obtained from EDX of cross-sectional particle. The ratio of Co_{edge}/Co_{center} exceeds 1.0 indicating enrichment of Co on the edge part of positive electrode active material particles. The edge enrichment of Co is originated from Co compound addition in the wet milling and second mixing process.

It is concluded that the combination of Y, Zr, and Co in the positive electrode active material as illustrated by EX1, EX2.1, and EX2.2 is synergistically beneficial to improve cycle life and decrease DCR value at 600 cycles.

1-15. (canceled)

16. A positive electrode active material for lithium-ion rechargeable batteries comprising Li, M′, and oxygen, wherein M′ comprises:
Ni in a content x, wherein x≥80 at %, relative to M′;
Co in a content y, wherein 0.01≤y≤20.0 at %, relative to M′;
Mn in a content z, wherein 0≤z≤20.0 at %, relative to M′;
Y in a content b, wherein 0.01≤b≤2.0 at %, relative to M′;
Zr in a content c, wherein 0.01≤c≤2.0 at %, relative to M′;
D in a content a, wherein 0≤a≤5.0 at %, relative to M′, wherein D is at least one element selected from the list of Al, Ba, Ca, Cr, Fe, Mg, Mo, Nb, S, Si, Sr, Ti, V, W, and Zn;
wherein x, y, z, a, b, and c are measured by ICP,
wherein x+y+z+a+b+c is 100.0 at %,
wherein the positive electrode active material comprises monolithic particles,
wherein the particles have a Co content Co_{edge} as measured by cross-sectional EDS (CS-EDS) at an edge of the particles, wherein Co_{edge} is expressed as at % relative to the sum of Ni, Mn, and Co content as measured by CS-EDS at the edge of the particles,
wherein the particles have a Co content Co_{center} as measured by CS-EDS at a center of the particle, wherein Co_{center} is expressed as at % relative to the sum of Ni, Mn, and Co content as measured by CS-EDS at the center of the particles, and
wherein the ratio Co_{edge}/Co_{center}>1.10.

17. The positive electrode active material according to claim 16, wherein each of the monolithic particles contains only one primary particle.

18. The positive electrode active material according to claim 16, wherein Co_{edge}/Co_{center}>1.50.

19. The positive electrode active material according to claim 16, wherein 85.0 at %≤x≤98.5 at %.

20. The positive electrode active material according to claim 16, wherein (y+z)>1.0 at %.

21. The positive electrode active material according to claim 16, wherein b≥0.02 at %.

22. The positive electrode active material according to claim 16, wherein c≥0.08 at %.

23. The positive electrode active material according to claim 16, wherein the particle median size D50 is at least 2.0 μm and at most 15.0 μm, as determined by laser diffraction particle size analysis.

24. A method for manufacturing a positive electrode active material according to claim 16, comprising the consecutive steps of:
a. Mixing a precursor comprising Ni and optionally either one or both of Co and Mn with a Y source, a Zr source, a Li source and optionally a D source to obtain a first mixture, wherein D is at least one element selected from the list of Al, Ba, Ca, Cr, Fe, Mg, Mo, Nb, S, Si, Sr, Ti, V, W, and Zn,
b. Heating the first mixture at a temperature between 650° C. to 1000° C. to obtain a first heated material,
c. Milling the first heated material to obtain a milled powder,
d. Mixing the milled powder with a Co source to obtain a second mixture, and
e. Heating the second mixture at a temperature between 500° C. to 900° C. to obtain the positive electrode active material.

25. The method according to claim 24, wherein the Y source is at least one selected from the group consisting of yttrium oxide, and yttrium zirconium oxide compound.

26. The method according to claim 24, wherein the Zr source is at least one selected from the group consisting of zirconium oxide, lithium zirconium oxide, and yttrium zirconium oxide compound.

27. The method according to claim 24, wherein the Y source and Zr source are yttrium zirconium oxide compound.

28. The method according to claim 24, wherein said first heated material is mixed in an aqueous solution comprising Co by using wet bead milling.

29. A battery comprising the positive electrode active material according to claim 16.
